(19) United States
(12) Patent Application Publication
(10) Pub. No.: US 2008/0243663 A1
(43) Pub. Date: Oct. 2, 2008

(54) Route Planning and Commodity Cost Estimating System

(76) Inventor: Ronald Eveland, Milwaukee, WI (US)

Correspondence Address: BOYLE FREDRICKSON S.C., 840 North Plankinton Avenue, MILWAUKEE, WI, 53203, US

(21) Appl. No.: 12/023,466

(22) Filed: Jan. 31, 2008

Related U.S. Application Data
(60) Provisional application No. 60/898,521, filed on Jan. 31, 2007.

(51) Int. Cl. G06Q 99/00; G01C 21/34

(52) U.S. Cl. 705/35; 701/202

(57) ABSTRACT

The present invention is a travel planning system including a commodity cost forecasting component and a route planning component that can be utilized in conjunction with one another to provide a commodity cost optimized route between locations supplied by a user of the system. The commodity cost forecasting component utilizes a suitable algorithm and current commodity cost information to provide an estimate of commodity costs at locations along an optimized route provided by the route planning component to travel between the point of origin and the destination supplied by the user to the system. The system also enables a user to determine the estimated commodity cost at a selected location, separately from planning a travel route to or from that location.

### CROSS-REFERENCE TO RELATED APPLICATIONS

This application claims priority from U.S. Provisional Patent Application Ser. No. 60/898,521, filed Jan. 31, 2007, the entirety of which is expressly incorporated by reference.

### FIELD OF THE INVENTION

The present invention relates to systems for determining routes between origination points and destinations, and more specifically to a system capable of providing additional information separate from the driving directions concerning the probable costs for a commodity, such as fuel, along the route.

### BACKGROUND OF THE INVENTION

When planning a trip from an origination point to a destination, often times various resources, such as the American Automobile Association, are consulted to determine the best route between the locations. The particular definition for the “best route” to be provided can be the fastest route, the shortest route or a route that maximizes other criteria for the route selected by the individual. Depending upon the particular criteria to be utilized, the system can determine the most appropriate route between the origination point and the destination point while providing the individual with additional information regarding the route, such as the total mileage and estimated time to complete the route.

One of the most popular types of resources for obtaining route planning information of this type are the various mapping systems provided on various website accessible through the Internet. These websites enable an individual to simply input the starting address for the trip and the destination, and the system will utilize suitable programming to determine the route to be taken by the individual, including the time required to complete the route, and any potential driving hazards, such as road construction that could affect the driving time for completion of the route. The systems accessed via these websites also can provide the individual with information regarding different businesses, such as restaurants and hotels, located along the route should the individual need to utilize any establishments of this type.

With rising energy costs, particularly with regard to gasoline prices, the particular routes chosen by individuals and businesses to travel between locations have become more important in order to minimize the associated travel costs based in large part on the commodity costs for traveling the distance between the locations. However, existing travel resources such as AAA and the various mapping websites that provide an individual or business with information concerning the route to be traveled between locations are only able to provide information concerning the overall distance and estimated time for travel between the locations.

Other resources have been developed that can provide an individual with the locations of the cheapest commodities, such as hotel rooms, meals from reputable restaurants and gas prices, at various locations that are entered by the individual. Certain of these resources also provide travel route-mapping or planning related services, such as www.MapOuest.com. However, these resources do not provide a travel route between the selected locations and require that the individual know the route such that the particular locations at which commodity prices are to be located on the route can be entered. In addition, the commodity prices provided by the resources are limited to the updates of the actual prices for commodity obtained directly from the businesses at the various locations, such that the price of the commodity at a location may change from the time the individual obtains the information to the time the individual reaches the location.

Therefore, it is desirable to develop a system which, in addition to supplying route information for traveling between selected locations, can also provide the user with information concerning the estimated commodity costs associated with a particular route provided by the system at the time when the individual will be traveling the route.

### SUMMARY OF THE INVENTION

According to one aspect of the present invention, the system of the present invention includes a route-determining, mapping or planning program that enables the individual to enter a point of origin and a destination, such that the program can determine and provide the individual with a travel route mapped between the origin and destination locations based on various criteria that may be provided by the individual in order to provide the best route as defined by the individual. The system also includes a travel commodity cost or price estimating program which utilizes a suitable algorithm to sample various prices for certain commodities, such as fuel, from different locations in real time in order to calculate an estimating factor for prospective costs for those commodities at any of a number of geographic locations. With this commodity price predicting information, when an individual accesses the system to determine a particular route between a selected origination point and a selected destination, the system, in addition to providing the user with the optimum route between the locations based on certain criteria selected by the individual, e.g., the time, distance, etc., between the selected locations, the system can also provide the user with an estimation of the commodity costs at various locations along the route to be traveled. This enables the user to estimate the commodity costs for a particular trip or trips to be taken over a given time.

According to another aspect of the present invention, the system can also enable the user to modify the provided route by entering parameters into the system that restrict the route to extend through areas which fall within particular commodity cost parameters input by the user into the system.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a schematic view of the commodity price forecasting component and route planning component of the present invention; and

FIGS. 2A-2B are schematic views of a flowchart illustrating the operation of the components of the system of FIG. 1.

### DETAILED DESCRIPTION OF THE INVENTION

With reference now to the drawing figure in which like reference numerals designate like parts throughout the disclosure, a system constructed according to the present invention is indicated generally at 10 in the drawing figure. The system 10 includes one or more suitable servers 11 that are operably connected to a worldwide data network, i.e., the Internet 13, in a known manner, and that contain both a commodity price or cost forecasting component 12 and a route planning component 14 thereon. The system 10 can be accessed in any known manner by an individual utilizing a suitable computing or communications device 15 that is operably connected to the system 10 over the worldwide data network.

The cost forecasting component 12 operates to provide an actual price-based forecast of the prices for a particular commodity, such as fuel, for example, over a number of geographical locations, such as metropolitan areas. The forecasting component 12 can operate in any suitable manner in order to determine a reasonable forecast for the fuel cost in a given metropolitan area, or any geographical area or location of interest.

In a preferred embodiment, the fuel cost forecasting component 12 operates to provide an actual price based forecast of the fuel prices for a number of geographic locations, such as regions, states, cities and metropolitan areas. The fuel forecasting component 12 can operate in any suitable manner in order to determine a reasonable forecast for the commodity coast in a given region, state, city or metropolitan area or any geographical area or location of interest.

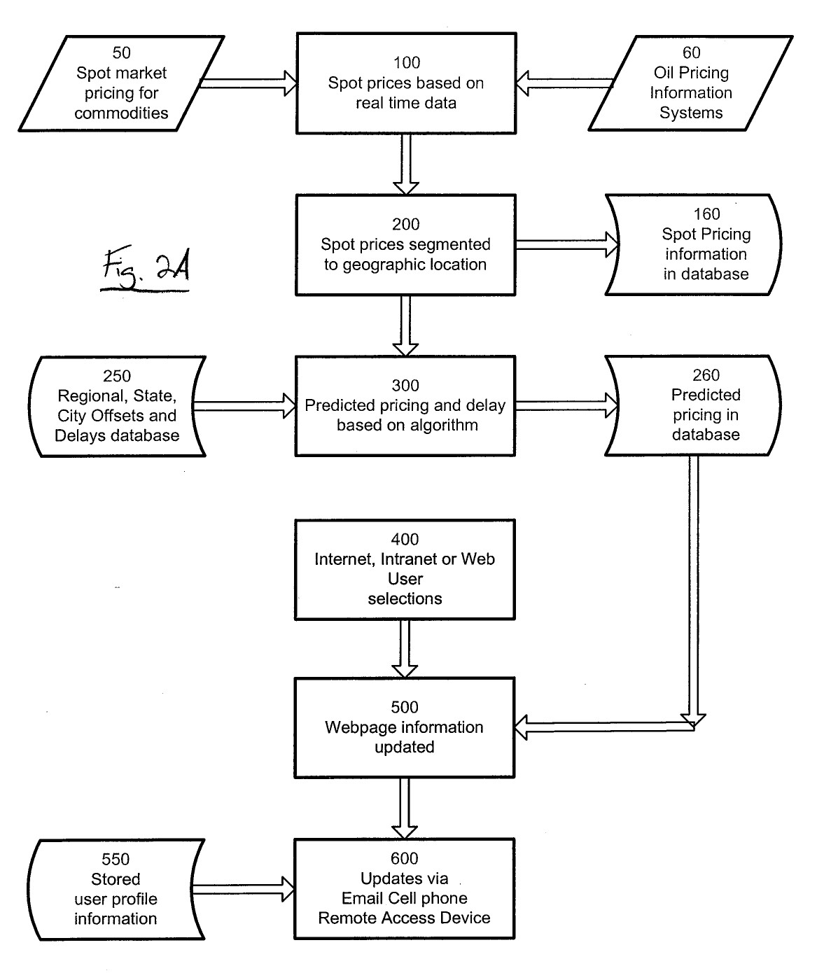

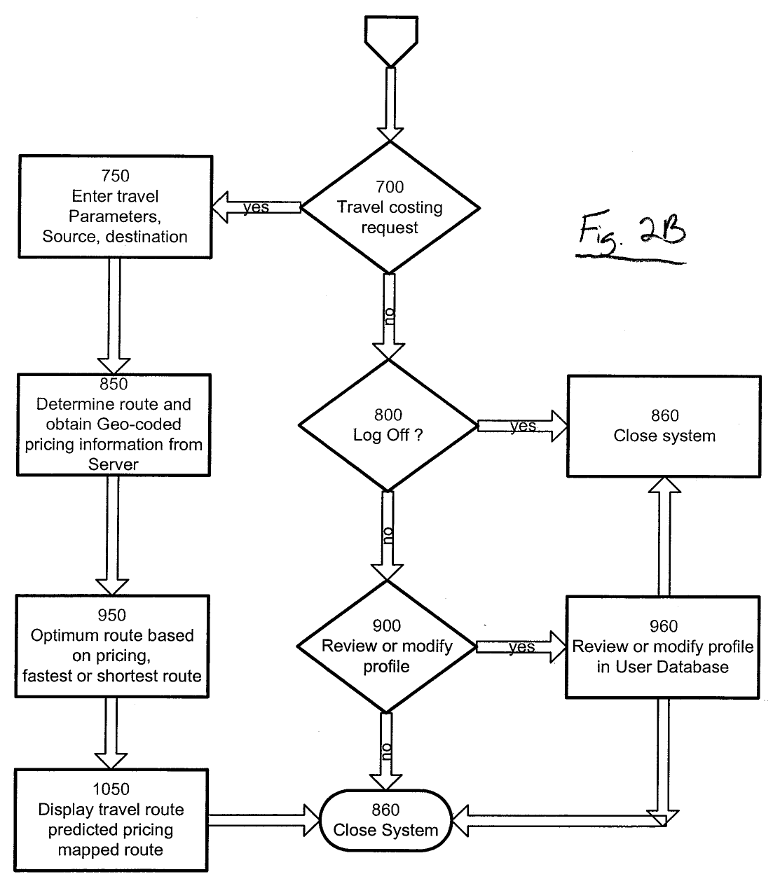

In a particularly preferred embodiment, fuel cost forecasting component 12 operates in the manner shown in FIG. 2A in block 100 by obtaining over the worldwide data network a spot price for ranges of commodities or petroleum products from specific sources in block 50, such as the New York Mercantile Exchange (NYMEX) and from other sources, such as Oil Pricing Information Systems, as shown in block 60. In processing this data, depending upon the desired manner of operation for the forecasting component 12, the fuel forecasting component 12 may also average the spot price over time, such as by continuously averaging the spot price as new data is obtained, or by averaging the spot price over certain set time periods. With regard to the NYMEX spot pricing obtained from block 50, this would result in NYMEX pricing for different types of fuels or commodities which would reflect market pressures and influences.

As another source for the pricing information, these prices are also provided by the U.S. Government through the Petroleum Administration of Defense District (PADD) which divides the country into regions to provide daily pricing for fuel types and also by Oil Pricing Information Systems regional data which may divide a geographic location based on harbor locations, pipeline transportation routes or major metropolitan areas. As an example of the geographic division, PADD 1 which includes New England, the Central and Lower Atlantic states, divides the geographic far eastern United States into a region. An example of an Oil Pricing Information Systems region would be Gulf Coast Waterborne or Boston Cargo.

Based on the commodity pricing information obtained and averaged in block 100, the fuel forecasting component 12 can then geographically code (Geo-Code) or convert the information to a latitude and longitude format based on a combination of PADD location and petroleum transportation routes and metropolitan areas in block 200. This spot pricing information based on a Geo-Coded format is then stored in a database indicated at block 160 for later retrieval by the forecasting component 12 of the system 10.

In addition, because of a combination of transportation route delays and commodity delivery methods, the actual prices, whether trending upwardly or downwardly, are seen by the consumer as time delays or offsets and are reflect in the spot price seen on the NYMEX or in the Oil Pricing Information System in when the price is paid by the consumer which is reflected in the weekly pricing information provided by the US government PADD prices. This delay can also be seen between the spot price increase or decrease and the actual price to the consumer as reflected by websites such as www.Gasbuddy.com. These delays or offsets can be analyzed and to a certain extent quantified within a region, a state, a city or a metropolitan area, and may become relatively constant over time. As such, the offset and its effects on the price of the commodity to the consumer can be reflected as intervals of time over which the effects of the delays and delivery methods affect the consumer prices, such as hours, days or weeks. Along with these delays, the transportation costs, the original spot price of the commodity, local and state taxes can also be determined as they are ultimately also reflected in the cost to the consumer for a particular commodity such as fuel. Therefore, each of these factors affecting the price of the commodity for the consumer may be used along with the time delays to predict the future pricing of a commodity in a particular area. This is done in the fuel forecasting component 12 in block 300 by determining and applying the offset/factor to the petroleum prices calculated in block 100 and geographically segmented in block 200 in order to gauge whether the prices at a given metropolitan location are trending upwardly or downwardly and to provide an estimate of the fuel costs at that location in the near future.

Initially, using the above factors, a baseline for these offsets may be determined in the system 10 and can then be divided into other area offsets within a particular region to provide a set of offsets for a pricing algorithm which can then be stored on the system 10 in any suitable form in the database illustrated by block 250 for later application by the forecasting component 12 in block 300. As an example of how these regional offsets can be determined, if the spot price increases on the NYMEX and the government PADD data reflects a price increase on a Thursday of the same week for the Houston metropolitan area, a delay of three days could be used as an offset for this metropolitan region. Further price reflections for areas outside the Houston metropolitan area can be seen by real-time pricing adjustments within Gasbuddy.com. Another offset can be found utilizing similar factors for the Miami metropolitan or other markets. The ratio of the two offsets along with the time delay in hours, days, weeks can be used to provide a predictive pricing algorithm for a selected area as would be known to someone of ordinary skill in the art having this data, so no further explanation of the algorithm is believed to be required as it can take any of a number of forms to provide the desired result. This is done by applying the factor to the petroleum prices in the specified area in order to gauge whether the prices at a given metropolitan location are trending upwardly or downwardly and to provide an estimate of the fuel costs at that location in the near future. The resulting estimated commodity prices can then be stored in database 260 for later use by the system 10 in response to a user request for information.

In addition, while the flowchart in FIG. 2A illustrates the steps and information utilized in obtaining the estimated fuel prices for a particular location, the process illustrated in FIG. 2A is preferably performed continuously by the fuel forecasting component 12 of the system 10, such that the information stored in each of databases 160, 250 and 260 is continually updated with newly received information to provide the user with the best estimate of the prices in response to a request. This allows the system 10 to provide constantly updated estimated commodity pricing information to a user who in block 400 has accessed the system 10 using a suitable device that is hardwired or wirelessly connected to the worldwide data network and inquired about estimated pricing for a particular geographic region. In making this request, the user can, for example, select from a menu driven system or enter a specific region, state, city or metropolitan area, as well as a time frame for which the price data is requested, such as one hour, one day, two days, one week or any other specified time period. In response to this request, in block 500 the system 10 accesses the predicted pricing information contained in database 260 concerning the selected region, and displays that information to the user in block 500, such as by showing the requested information on a website (not shown). Alternatively, the system 10 can determine a new estimated price for the commodity as a result of the combination of the stored pricing, offset, algorithm and delay information stored in the various components of the system 10.

The delivery of the predicted pricing in response to the user request in block 400 could also be based on a user profile entered while at a web interface or stored previously in a user profile database 550 connected to the system 10. Additionally, the selection criteria and the users profile could allow for updates from the system 10 in block 600, such as via an email format, a cell phone or handheld device or some type of remote notification/access device. This update could be periodic, based on commodity prices trending upwardly or downwardly, or based on other update criteria supplied by the user in block 400 and/or stored in the database 550.

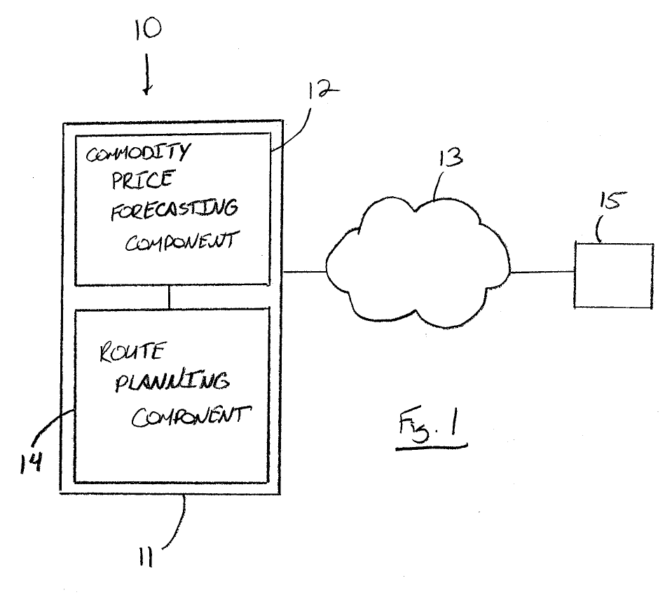

Looking now at FIGS. 1 and 2B, the system 10 also includes a route planning system 14 that can be utilized by the user in conjunction with the fuel forecasting system 12 and that utilizes a suitable road status information system and accompanying algorithm or software, such as that utilized by the Mapquest® website, for example. The algorithm or software for the route planning system 14 allows a user to input a particular origination point and destination, such that the route planning system 14 can then use the algorithm to determine the optimum route to be taken between the locations specified by the user. The criteria to be utilized in determining the optimal route can be modified by the user such that the route selected can be the shortest route, or the fastest route, the route with the least expensive cost, or those routes with costs below a specified maximum, among others.

When a user is utilizing the system 10 to plan a travel route in the manner as shown in the flowchart illustrating the operation of the system 10 in FIG. 2B, during the processing of the optimal route utilizing the information input by the user, the system 10 also utilizes the estimate calculated by the fuel forecasting system 12 to determine the estimated fuel prices at a number of locations disposed along the route obtained from the algorithm in the component 14. The user can then get information concerning an estimate of the potential fuel cost for traveling a route between the selected locations. Additionally, with the fuel cost estimator component 12, the system 10 can utilize the components 12 and 14 simultaneously in order to enable the user to optimize the route to be provided between the identified locations by a lowest fuel cost route utilizing the estimated fuel prices provided by the fuel forecasting component 12.

In this process, initially the user accesses the system 10 utilizing a suitable user access device, such as a home or laptop computer, personal wireless data device, or dedicated terminal connected to the system 10 over the Internet or an Intranet, or any other suitable interface and is queried in block 700 whether they want to input a travel planning/costing request. If the user wishes to input a travel request, in block 750 the user inputs the information regarding the planned trip, including the point of origin, the destination and all other parameters that are required by the user for the trip, including the time frame in which the trip is to be taken, the type of vehicle and its gas mileage that is to be used in making the trip, and the type(s) and weight of cargo to be carried in the vehicle making the trip, among any other relevant information supplied by the user.

Using this information supplied in block 750, the system in block 850 will calculate a route from the point of origin to the destination using the road status information and the mapping algorithm/software in the route planning component 14. Further, utilizing the fuel forecasting component 12, the system 10 will access the Geo-Coded data regarding the estimated fuel prices for the area or areas through which the trip is to be taken.

At this point, in block 950 the system 10 can utilize the criteria supplied by the user in block 750 at the primary factor(s) to be used in determining the optimal route and apply them to the data obtained on the route based on the predictive pricing data from forecasting component 12 and the route planning information from mapping component 14. The criteria supplied by the user can be whether the route desired is the shortest in terms of travel time, the shortest in terms of overall distance, the routes having an overall cost below a preset maximum cost, and/or the cheapest in terms of overall gas price for the entire trip, one way or round trip.

Once the system 10 has calculated the optimal route based on the various inputs and criteria supplied by the user, the system 10 provides the user with the final determination of the optimized route in block 1050 that can then be employed by the user to make the trip. After receiving the information from block 1050, the user can then exit the system in block 860.

Additionally, should the user not wish to submit a travel costing request in block 700, the system 10 will direct the user to block 800 where the user can elect to log off, or view and/or modify the profile for the user that is stored in the database 550. If the user wishes to log off, the user is then directed to block 860 where the system 10 is closed. However, if the user wishes to access his or her profile, the user is directed to block 960 to review his or her profile, as well as any prior travel costing requests that have been stored in the database 550 in the user's profile. Once the user has completed reviewing or modifying the profile in database 550, the user can then move to block 860 and exit the system 10.

The system 10 may also include other components often utilized in web-accessible systems of this type, such as any of the various login and payment components that are normally associated with proprietary systems provide and utilized over the Internet.

In other embodiments of the present invention the system 10 can be utilized to calculate routes and estimate fuel costs for vehicles other than motor vehicles, such as planes or boats/ships, and can utilize weather forecasting tools to assist in planning route for these types of vehicles. Also, those commodities for which the price or cost forecasting component 12 is designed for use as discussed in the present invention are not limited to fuel or fuel products alone, but may apply to other commodities such as hotel and/or motel rooms, among others.

Various alternatives are contemplated as being within the scope of the following claims particularly pointing out and distinctly claiming the subject matter regarded as the invention.

What is claimed is:

1. A travel planning system comprising:
a) a route planning component configured to provide one or more possible routes between an input point of origin and a destination; and
b) a commodity price forecasting component configured to provide an estimate of the commodity prices associated with the routes supplied by the route planning component.

2. The system of claim 1 wherein the commodity price forecasting component is configured to provide the estimate of commodity prices for future travel along the routes.

3. The system of claim 1 wherein the commodity price forecasting component is configured to utilize spot price data and offset factors in determining the commodity price estimate.

4. The system of claim 3 wherein the commodity price forecasting component is configured to geographically code the spot price data and the offset factors.

5. The system of claim 1 further comprising a user input device operably connected to the route planning system and the commodity price forecasting component and configured to enable a user to input trip criteria for use by the route planning system to determine various routes for the trip, and user optimizing criteria for use by the route planning component and the commodity price forecasting system in determining the optimal route based on the user optimizing criteria.

6. The system of claim 5 wherein the user trip criteria comprises the point of origin, the destination, the time frame in which the trip is to be taken, the type of vehicle and its gas mileage that is to be used in making the trip, the type(s) and weight of cargo to be carried in the vehicle making the trip.

7. The system of claim 5 wherein the user optimizing criteria is selected from the group consisting of: the shortest route in terms of travel time, the shortest route in terms of overall distance, and the cheapest route in terms of overall gas price for the entire trip, one way or round trip.

8. A commodity price forecasting system comprising a processing device operably connected to a worldwide data network and configured to access an obtain spot price data for the selected commodity, to average the spot price data over time to develop a forecasting function for the price of the commodity, geographically code the averaged spot price data based on the locations for which the spot price data is obtained, and to provide an estimate of the commodity price for a specified location in response to a request from a user from a remote communications device.

9. The commodity price forecasting system of claim 8 wherein the processing device is further configured to develop an offset for the averaged spot price data for a particular geographic location to be used in estimating the commodity price for a specified geographic location.

10. The commodity price forecasting system of claim 9 wherein the processing device is configured to obtain data pertaining to transportation route delays for the selected commodity, commodity delivery methods, original spot prices of the commodity, transportation costs for the commodity, local and state taxes for a particular geographic location to be utilized in obtaining the offset employed in determining the estimated commodity price.

11. The commodity price forecasting system of claim 8 further comprising a route planning component located on the processing device, and wherein the processing device is configured to receive point of origin and destination information from a user on the remote communications device, to determine a route between the point of origin and destination, and to provide estimates of the prices for the commodity at various geographic locations located along the route.

12. The commodity price forecasting system of claim 11 wherein the processing device is further configured to optimize the route between the point of origin and the destination based on optimization criteria provided by the user.

13. A method for determining the cost for travel along a route, the method comprising the steps of:
a) providing a system including a route planning component and a commodity price estimating component;
b) entering a relevant trip planning criteria including a point of origin and a destination into the route planning component to be utilized in determine a route; and
c) estimating prices of the commodity at geographic locations along the route.

14. The method of claim 13 wherein the step of estimating prices of the commodity at geographic locations along the route further comprises the steps of:
a) obtaining spot price data for the selected commodity in a number of geographic locations;
b) averaging the spot price data over time for each of the geographic locations to develop a forecasting function for the price of the commodity;
c) geographically coding the averaged spot price data based on the locations for which the spot price data is obtained; and
d) providing an estimate of the commodity price for locations disposed along the route.

15. The method of claim 14 wherein the step of averaging the spot price data further comprises the step of developing an offset for the averaged spot price data for a particular geographic location to be used in forecasting the commodity price for a specified geographic location.

16. The method of claim 15 wherein the step of developing an offset comprises:
a) obtaining data pertaining to transportation route delays for the selected commodity, commodity delivery methods, original spot prices of the commodity, transportation costs for the commodity, and local and state taxes for a particular geographic location; and
b) utilizing this data to determine the offset employed in determining the estimated commodity price for the particular location.
